(19) United States
(12) Patent Application Publication
(10) Pub. No.: US 2001/0052556 A1
(43) Pub. Date: Dec. 20, 2001

(54) Injector

(76) Inventors: Weichi Ting, Kaohsiung (TW); Lihwoei Chen, Nantou Hsien (TW); Chin-Chuan Chung, Hsinchu Hsien (TW); Vince Chen, Hsinchu (TW)

Correspondence Address: J.C. Patents, 4 Venture, Suite 250, Irvine, CA, 92618, US

(21) Appl. No.: 09/827,826

(22) Filed: Apr. 5, 2001

Related U.S. Application Data
(63) Continuation of application No. 09/261,097, filed on Mar. 2, 1999, now abandoned.

(30) Foreign Application Priority Data
Dec. 14, 1998 (TW) 87120712

(51) Int. Cl. B05B 1/14

(52) U.S. Cl. 239/556; 239/560

(57) ABSTRACT

The invention provides an injector. A first nozzle on top of the injector is provided, and a plurality of second nozzles on the injector sidewall is provided. An inner diameter of each second nozzle is gradually decreased from top to bottom on the injector sidewall.

### CROSS-REFERENCE TO RELATED APPLICATION

This application is a continuation application of, and claims the priority benefit of, U.S. application Ser. No. 09/261,097, filed Mar. 02, 1999.

### BACKGROUND OF THE INVENTION

1. Field of the Invention

The present invention relates to an injector. More particularly, the present invention relates to a mixed-type injector for a vertical furnace.

2. Description of the Related Art

There are two kinds of injectors in a conventional furnace chamber, one injector has a nozzle at the top of the injector, and a carrier gas or reaction gas is transported from the nozzle at the top of the injector to a chamber. The drawback of this device is that the carrier gas or reaction gas cannot pre-mix for a more uniform distribution in the chamber. The other kind of injector has three nozzles on the injector sidewall and seals the top of the injector; the carrier gas or reaction gas is transported from the three nozzles on the injector sidewall to a chamber. The advantage of this device is that the carrier gas or reaction gas can pre-mix for a more uniform distribution in the chamber. The drawback of this device is that it causes a deposit accumulation on top of the injector that further clogs the nozzles on the injector sidewall. When another series of the carrier gases or reaction gases diffuse into the injector, a deposition reaction occurs, and the reaction generates deposit that accumulates at the top of the injector because the top of the injector closed. As a result, the nozzles on the injector sidewall become clogged.

### SUMMARY OF THE INVENTION

Accordingly, one object of the present invention is to provide an injector that can uniformly distribute the carrier gas or reaction gas in the furnace chamber.

Another object of the present invention is to provide an injector that can prevent a deposit accumulation at the top of the injector and avoid clogging the nozzles on the injector sidewall.

To achieve these and other advantages and in accordance with the purpose of the invention, the invention provides an injector, wherein a carrier gas or a reaction gas is transported through the injector to a furnace chamber. The device includes a first nozzle at top of the injector and a plurality of second nozzles on the injector sidewall.

To achieve these and other advantages and in accordance with the purpose of the invention, as embodied and broadly described herein, the invention provides an injector, wherein a carrier gas or reaction gas is transported through the injector to a chamber of a furnace. The device includes a first nozzle at the top of the injector, and a plurality of second nozzles on the injector sidewall. An inner diameter of each second nozzle is gradually decreased from top to bottom on the injector sidewall. If the whole injector has an equal inner diameter, an inner diameter of a first nozzle at the top of the injector is smaller than the inner diameter of the injector. If the inner diameter of the top of the injector is smaller than the bottom of the injector, the inner diameter of the first nozzle at the top of the injector is the same as the inner diameter of the top of the injector.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic, cross-sectional view of a batch vertical furnace according to this invention; and

FIG. 2 is a schematic, structural view of an injector according to the preferred embodiment of this invention.

FIG. 3 is a schematic, structural view of an injector for use in a plasma processing chamber according to various embodiments of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

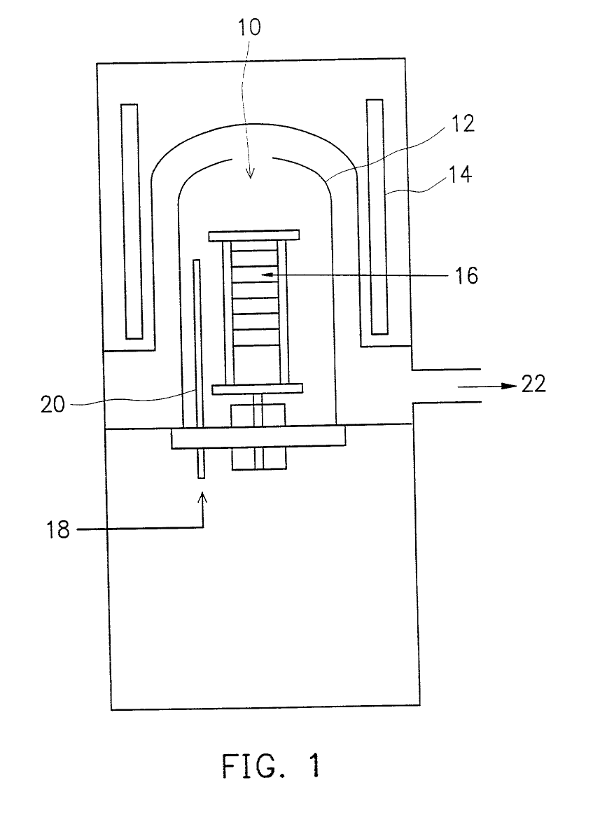

FIG. 1 is a schematic, cross-sectional view of a batch vertical furnace according to this invention. Referring to FIG. 1, a furnace chamber 10 is made of suitable material such as quartz. The furnace chamber 10 contains a quartz tube 12 and the outside of the quartz tube 12 is surrounded with a heater 14. A wafer 16 is placed on a wafer boat; the wafer boat is placed in a predetermined position of the furnace chamber 10 to favor performance of a deposition process. The carrier gas or reaction gas is transported from a gas inlet 18 through an injector 20 into the chamber 10 to perform the deposition process. Different carrier gases or reaction gases are transported from different gas inlets 18 through different injectors 20 to the chamber 10, respectively. The same species of the carrier gases or reaction gases can be also transported from different gas inlets 18 through different injectors 20 to the chamber 10. Therefore, a deposition reaction is generated, and then the deposit is produced on the wafer. The exhaust gas produced by deposition reaction is exhausted out through a gas outlet 22.

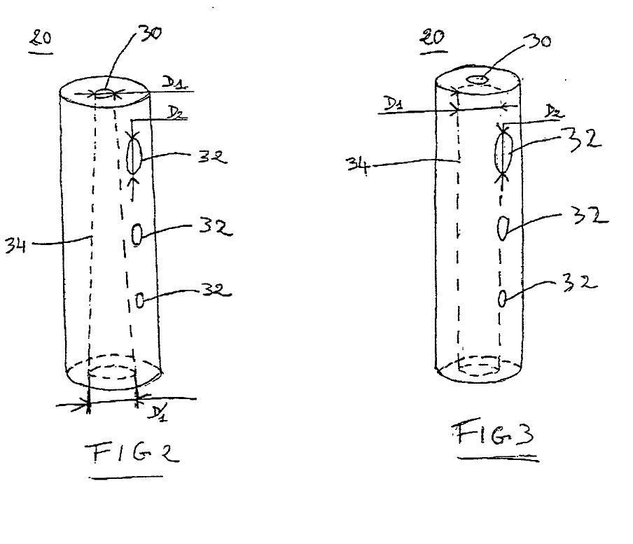

Referring now to FIG. 2 and FIG. 3, there are shown schematic views illustrating various the injector according to various embodiment of the present invention.

The invention provides an injector 20. The injector 20 is made from a suitable material such as stainless steel or quartz. Preferably, the injector 20 has a cylindrical shape although other suitable shapes are also applicable. There is a through channel 34 in the injector 20 along its longitudinal axis. Preferably, the through channel 34 has a cylindrical shape. The injector 20 has a first nozzle 30 at the top end of the injector 20 and a plurality of second nozzles 32 on the injector sidewall. A gas inlet 18 (FIG. 1) is connected to the bottom end of the injector 20. With reference to FIG. 2, if the inner D₁ diameter of the channel at the top end of the injector 20 is smaller than that D₁ at the bottom end of the injector 20, the inner diameter D₁ of a first nozzle 30 at the top end of the injector 20 is the same as the inner diameter of channel 34 at the top end of the injector 20. With reference to FIG. 3, if the channel 34 of the injector has a uniform inner diameter from top to bottom, the inner diameter of the first nozzle 30 at the top of the injector 20 is made smaller than the inner diameter of the channel 34 of the injector 20. The number of second nozzles 32 on the injector sidewall may vary and is not limited; the plurality of the second nozzles 32 on the injector 20 sidewall can be arranged in a line so that the plurality of the second nozzles 32 face the chamber 10 center, for example. The inner diameter D₂ of each second nozzle 32 is gradually decreased from top to bottom. Carrier gas or reaction gas flows into the injector 20 from the bottom to the top. Since a higher point of the injector 20 has a less flux density, the inner diameter of each second nozzle 32 should gradually increase from the bottom to the top so as to obtain an equal total flux at each second nozzle 32. The distribution range of the first nozzle 30 and the plurality of the second nozzles 32 are the same as the wafer 16 (FIG. 1) set on the wafer boat. For example, the number of the second nozzles 32 on the injector 20 sidewall is three (shown in FIG. 2), and the second nozzles 32 are located at the top, center and bottom, between the top of the injector 20 and the gas inlet 18, respectively.

The injector 20 combines two advantages. One is that the carrier gas or reaction gas can pre-mix more uniformly. The other is that the deposit cannot accumulate on the top of the injector 20 and further clog the nozzles on the injector sidewall when another species of carrier gases or reaction gases diffuses into injector 20 to instigate a deposition reaction.

(1) The invention provides an injector having a nozzle at the top of the injector, and a plurality of the nozzles on the injector sidewall.

(2) The invention provides an injector having a nozzle at the top of the injector, and a plurality of the nozzles on the injector sidewall, in which the nozzle at the top of the injector can eject the deposit to prevent the deposit accumulation on the top of the injector and avoid clogging the plurality of the nozzles on the injector sidewall with the deposit. The plurality of the nozzles on the injector sidewall can uniformly distribute the carrier gas or reaction gas in the chamber.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An injector for use in a wafer processing chamber and having a longitudinal body with a top end, a bottom end, a sidewall and a through channel in the body along its longitudinal axis for transporting a carrier gas or reaction gas from a gas outlet to a chamber of a furnace, the injector comprising:
a first nozzle located at the top end of the injector and connected to the channel; and
a plurality of second nozzles located aloong the sidewall of the longitudinal body of the injector and connected to the channel, wherein the plurality of second nozzles has an inner diameter that decreases from the top end to the bottom end of the injector such that, with the longitudinal body installed with the bottom end connected to the gas outlet outside of the chamber, the first nozzle and the second nozzles have a same distribution rang of gas transported thereby to a wafer in the chamber.

2. The injector of claim 1, wherein the channel has a cylindrical shape and its inner diameter is substantially uniform from the top end to the bottom end.

3. The injector of claim 2, wherein inner diameter of the first nozzle is smaller than that of the channel.

4. The injector of claim 1, wherein inner diameter of the channel at the top end of the injector is smaller than that at the bottom end of the injector.

5. The injector of claim 4, wherein inner diameter of the first nozzle is the same as that of the channel at the top end.

6. The injector of claim 1, wherein the injector material includes stainless steel.

7. The injector of claim 1, wherein the injector material includes quartz.

8. An injector for use in a wafer processing chamber and having a longitudinal body with a top end, a bottom end, a sidewall and a through channel having a uniform cylindrical shape in the body along its longitudinal axis, the injector comprising:
a first nozzle located at the top end of the body of the injector and connected to the channel wherein the first nozzle has an inner diameter smaller than the inner diameter of the channel and spray a gas transported through the channel; and
a plurality of second nozzles, wherein the plurality of second nozzles is located along the sidewall of the body and has an inner diameter that gradually decreases from the top end to the bottom end of the longitudinal body in such a manner that the gas transported through the channel is distributed with a same flux through each of the plurality of second nozzles.

9. An injector for use in a wafer processing chamber and having a longitudinal body with a top end, a bottom end, and a sidewall, and a through channel located in the body along its longitudinal axis and having an inner diameter that is smaller on the top end than on the bottom end of the injector, wherein the gas to be injected is provided from the bottom end of the injector, the injector comprising:
a first nozzle located at the top end of the injector and connected to the channel, wherein the first nozzle has an inner diameter equal to the inner diameter of the channel on the top end of the injector; and
a plurality of second nozzles located along the sidewall of the longitudinal body of the injector, wherein the diameter of each of the plurality of second nozzles decreases from the top end to the bottom end such that the gas flux through each of the second nozzles is identical along the longitudinal body of the injector.
